(19) United States
(12) Patent Application Publication
(10) Pub. No.: US 2009/0250241 A1
(43) Pub. Date: Oct. 8, 2009

(54) Cable and process for manufacturing the same

(76) Inventors: Franco Galletti, Milano (IT); Carlo Soccal, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/227,597

(22) PCT Filed: May 22, 2006
(86) PCT No.: PCT/IB2006/051634

§ 371 Date: Jan. 8, 2009

(51) Int. Cl. H01B 3/30; B29C 47/00

(52) U.S. Cl. 174/110 SR; 264/176.1

(57) ABSTRACT

A cable for applications which entails heavy mechanical stresses and/or harsh environmental conditions includes at least one core having at least one transmissive element and an outer sheath disposed in radially external position with respect to the core. The outer sheath includes a reinforcing layer including a fibril reinforced polymeric matrix. A process for manufacturing such a cable includes the steps of providing a core having at least a transmissive element; providing a first compound of fibrils and a matrix; and applying the first compound around the core to form the reinforcing layer including the fibril reinforced polymeric matrix. The invention also deals with the use of fibrils for the manufacturing of a coating layer for a cable.

### FIELD OF THE INVENTION

The present invention relates to a cable as well as to a process for manufacturing a cable.

Certain cable applications require the cable to be provided with insulation protected by a sheath more suitable to withstand mechanical stresses and/or harsh environmental conditions than conventional sheaths typically made of extruded polymeric material.

Sheaths suitable for these applications typically comprise a reinforcing layer made of non-extruded material that in the following of the present description shall be referred to as “discontinuous layer”, for example a metallic braid.

Among these applications there are the so-called “heavy-duty” applications which include, for example cables used to convey electric energy to a trolley travelling along an arm of a crane. In this case the cable presents a first fixed extremity connected e.g. to the electricity grid and a second mobile extremity connected to and following the mobile parts of the crane.

Typically, these cables are subject to inertial forces due to the accelerations the cable is put through, said forces being a function of the weight of the cable itself, and to bending forces, for example because the cable has to follow the shape of the structure where it is installed and the movement of the same structure.

The cable is therefore subject to repeated bending and pulling strains, which strains cause fatigue damaging.

Furthermore, the heavy-duty cables are typically stored on winding reels in a rolled up configuration. During the unrolling from the cited winding reels, the cables slides into cable raceways or channels and run on cable carrier sheaves, tender systems or guide pulley systems. While the cable is guided on or into all these devices, it can be subject to high longitudinal accelerations and bending angles.

In addition, the sliding of the cable during operation produces a wearing of the outer surface of the same and possible tears.

Finally, the coils of the cable on the reel can be not in order and not correctly placed side by side. Therefore, during the unrolling steps, the cable is subject to sudden pulls and wrenches. Such pulls stretch the cores and tend to untwist the same cores, generating stresses originating from the inside of the cable.

### STATE OF THE ART

WO06000244 discloses a cable with improved environmental stress cracking resistance by virtue of a polyethylene composition used as coating layer, preferably as external sheathing layer of the cable. In an embodiment, inside the external sheathing layer there is a tensile reinforcing layer (for example a glass fiber or a polyaramide (i.e. aromatic polyamide) fiber such as the product known commercially as Kevlar®).

EP1065674 deals with a down-hole cable for use in an oil or gas well or a water injector well, comprising a pair of conductors for transmission of power and/or data, and a load-bearing member which is separate from the pair of conductors. The load-bearing member preferably comprises a sleeve surrounding the conductors. A preferred material for the load-bearing member is a polymer fibre or yarn, such as Zylon™ PBO (poly(p-phenylene-2,6-benzobisoxazole)), polyamide or polybenzimidazole, which is woven or wound around the inner core. Alternatively, an aramid (i.e. aromatic polyamide) fibre such as Kevlar® may be utilised as the material for the load bearing-member. The load-bearing member is formed on the core of the cable by a weaving apparatus.

The reinforcing layers or load-bearing members of the prior art which comprise a “discountinuous layer” shall be referred to as “composite outer sheath”.

According to the present description, as “discontinuous layer” it is intended a layer made of elongated elements arranged a non-continuous manner in longitudinal or circumferential direction, for example in form of braid or tape or filament. The elongated elements forming the discontinuous layer can be made of natural, polymeric or metallic material, or a combination thereof. A discontinuous layer can provide mechanical, anti-torsion and/or thermal protection, and/or hold up the conductors untwisting.

In the present description, the cable element comprising a discontinuous layer could be referred to as “composite sheath”.

A composite sheath can comprise a first extruded layer, a discontinuous layer circumferentially provided in radial position on said first layer, and at least one second extruded layer circumferentially provided in radial position on said discontinuous layer. The first and second extruded layers are polymeric layers, preferably in heavy-duty polymeric compound, provided by extrusion during the manufacturing the cable.

### SUMMARY OF THE INVENTION

The Applicant experienced that the discontinuous layer of the composite sheath, though sunk into the polymeric material of the first and second extruded layers, is an interruption in the sheath structure, which discontinuity can give rise to electrical and mechanical defects.

The Applicant aimed at reducing the weight, the size and the rigidity of the known cables. Indeed, the multiple layers structure of the composite sheath as disclosed in the prior art gives the cable a bulky structure, in terms of large diameters, a heavy weight and high rigidity, in particular if the above detailed discontinuous layer is metallic.

The Applicant understood that the heavy weight of the known cables affects the weight and the cost of the overall equipment, such as the crane or the mobile equipment. Indeed, the load-bearing structures and the power of the engines moving the mobile parts of the crane must be dimensioned accordingly.

The weight and the rigidity of the cable limit also the working speed of the equipment (e.g. speed of the crane trolley) and/or increase the inertial forces and stresses acting on the cable itself.

In addition, the rigidity of the cables prevents the cable to be arranged on the equipment assuming high curvature radii and, therefore, it is a constraint to the possible design options of the apparatus in which the cable is used.

The known art solutions for manufacturing the cable sheath comprise at least three steps: the extrusion of a first layer, the laying of the discontinuous layer and the extrusion of a second layer thereupon. Typically, the discontinuous layer is woven or wound over the first extruded layer, this step taking time and requiring additional machines to be carried out.

The Applicant found that a reinforcing layer comprising a fibril reinforced polymeric matrix could provide the cable with such a mechanical strengthening to replace the whole composite outer sheath, first and second extruded layers included.

Ina another aspect, the Applicant has perceived that the process for manufacturing a heavy duty cable is significantly simplified by applying the reinforcing sheath in form of an extruded fibril reinforced polymeric matrix.

Therefore, in a first aspect, the present invention relates to a heavy-duty cable comprising: at least one core having at least one transmissive element; an outer sheath disposed in radially external position with respect to said core; wherein said sheath comprises at least one reinforcing layer comprising a fibril reinforced polymeric matrix.

Preferably, the cable of the present invention is a heavy-duty cable.

In an embodiment of the present invention, said sheath comprises of at least one reinforcing layer consisting of a fibril reinforced polymeric matrix.

In an embodiment of the present invention, said sheath consists of one reinforcing layer consisting of a fibril reinforced polymeric matrix.

Preferably, the fibril reinforced polymeric matrix comprises an elastomeric material.

Examples of elastomeric materials are: natural rubber, ethylene/vinyl acetate copolymer (EVA); chlorosulfonated polyethylene; polychloroprene (PCP); chlorinated polyethylene (CPE); styrene-butadiene rubber (SBR); acrylonitrile-butadiene rubber (NBR).

Advantageously, the fibril reinforced polymeric matrix of the invention comprises from 1 to 30 phr of fibrils, preferably from 2 to 15 phr of fibrils, where the unit “phr” stands for “parts by weight per 100 parts by weight of rubber”.

The fibrils can be of inorganic (e.g. glass, metallic) or organic (e.g. carbon, polymeric, lignocellulosic) material. Examples of polymeric material are polyamide and polypropylene, preferably polyamide material, more preferably aromatic polyamide, e.g. polypara-phenylene terephthalamide.

In an embodiment of the present invention, the outer sheath of the cable comprises at least one layer of non-fibril-reinforced polymeric material.

In a further aspect, the present invention relates to a process for manufacturing a cable, comprising the steps of: providing a core having at least a transmissive element; providing a first compound of fibrils and a matrix; applying the first compound around the core to form a reinforcing layer comprising a fibril reinforced polymeric matrix, said layer being disposed in radially external position with respect to said core.

Preferably, the first compound is extruded on the core.

In another aspect, the present invention relates to the use of fibrils for the manufacturing of a coating layer for a cable.

Advantageously, the fibrils are used for manufacturing a reinforcing coating layer for a cable.

In the present description and claims as “coating layer” it is meant a continuous layer circumferentially arranged around an underlying element of the cable.

The cable according to the present invention comprises at least one core, including at least one transmissive element, and an outer sheath disposed in radially external position with respect to said core.

In particular, in the present description and claims as “heavy duty cable” it is meant a cable for applications which entail heavy mechanical stresses and/or harsh environmental conditions, such as cranes or mobile equipment for maritime trade ports, freight yards or for mining and/or off-shore applications.

In the present description and claims as “outer sheath” is intended a layer or groups of layers surrounding the insulation providing the cable with mechanical protection and/or resistance.

In the present description and in the subsequent claims, the term “core” of a cable is used to indicate a semi-finished structure comprising a transmissive element, such as an electrical energy conductor, an optical signal transmissive element (e.g. an optical fiber) or a composite element transmitting both electrical energy and optical signals, and at least one electrical isolation or, respectively, at least one containment element (for example a tube, a sheath, a micro sheath or a grooved core), or at least two elements, one of which is an electrical isolation element and one is a containment element, arranged at a radially outer position with respect of the corresponding transmissive element.

In the core, the transmissive elements are preferably arranged in a twisted configuration, i.e. the elements are twisted together in an helix having a predetermined lay (left or right hand). Such a configuration helps to reduce the possible stress on the transmissive elements and improve the cable flexibility.

As an illustrative example, we consider a cable for transporting or distributing low/medium voltage electrical energy (where low voltage indicates a voltage lower than 1 kV, whereas medium voltage indicates a voltage of from 1 kV to 35 kV).

In the present description and in the subsequent claims, the term “optical signal transmissive element” is used to indicate any transmission element comprising at least one optical fibre. Such a term identifies both a single optical fibre and a plurality of optical fibres, optionally grouped together to form a bundle of optical fibres or arranged parallel to each other and coated with a common coating to form a ribbon of optical fibres.

In the present description and in the subsequent claims, the term “combined electro-optical transmissive element” is used to indicate any element or combination of elements capable of transmitting both electrical energy and optical signals in accordance with the abovementioned definitions.

When a plurality of cores are present in a cable, the cable can be referred to as “bipolar cable”, “tripolar cable” and “multipolar cable” depending on the number of cores incorporated therein (in the mentioned cases in number of two, three or greater, respectively).

In accordance with such definitions, the present invention refers to cables provided with one or more cores of any type. In other words, the present invention refers to unipolar or multipolar cables, of the electric type for transporting or distributing electrical energy, or of the optical type comprising at least one optical fibre or of the combined electro-optical type.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

Further features and advantages will become more apparent from the detailed description of some preferred, but not exclusive, embodiments of a heavy-duty cable, as well as from a method for manufacturing a heavy-duty cable, in accordance with the present invention.

### BRIEF DESCRIPTION OF THE DRAWINGS

This description will be set out hereinafter with reference to the accompanying drawings, given by way of non-limiting example, in which:

FIG. 1 shows in cross section a cable according to an embodiment of the invention;

FIG. 1a shows a perspective view of a length of the cable of FIG. 1, with parts removed in order to reveal its structure;

FIG. 2 shows in cross section a cable according to a further embodiment of the invention;

FIG. 3 shows in cross section a cable according to a further embodiment of the invention;

FIG. 3a shows a perspective view of a length of the cable of FIG. 3, with parts removed in order to reveal its structure;

FIG. 4 shows in cross section a cable according to a further embodiment of the invention;

FIG. 5 shows in cross section a cable according to a further embodiment of the invention; and

FIG. 6 shows a schematic longitudinal section of an extrusion apparatus for carrying out the manufacturing method according to the invention, during the extrusion of the cable of FIG. 2.

### DETAILED DESCRIPTION OF THE PREFERRED EMBODIMENTS

With reference to the attached drawings, a heavy-duty cable in accordance with the present invention is generally identified by reference numeral 1.

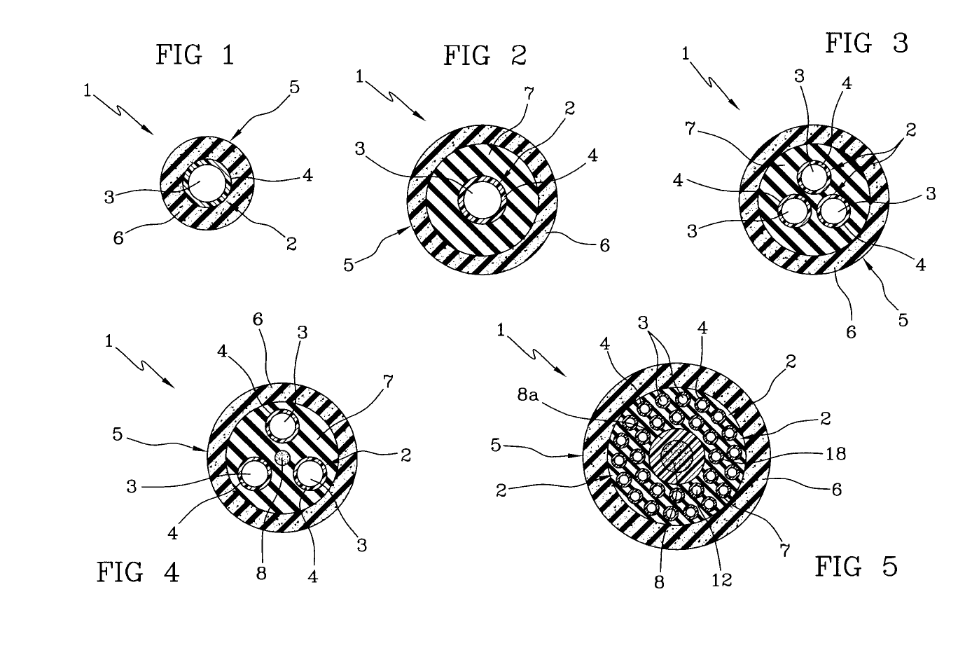

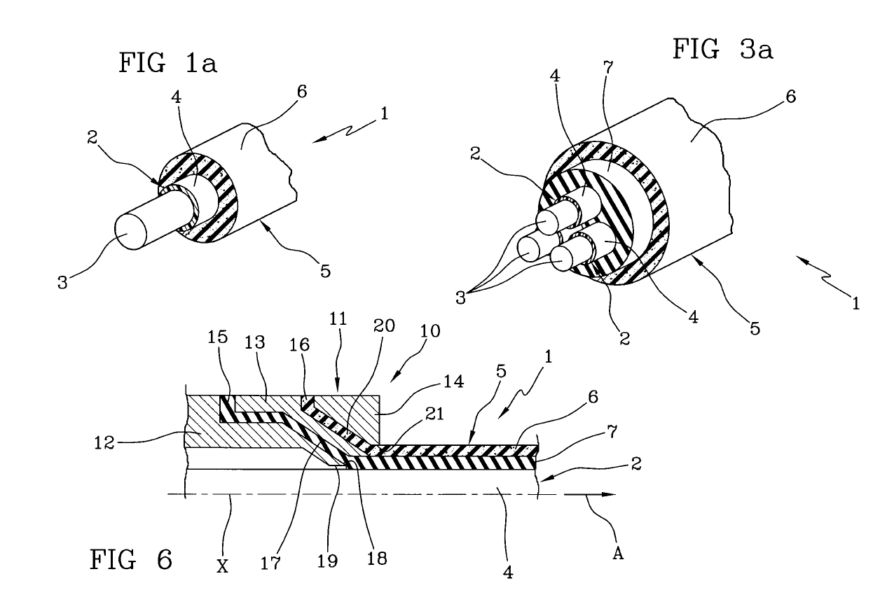

The heavy-duty cable 1 comprises at least one core 2, which core 2 presents at least one transmissive element 3. Referring to the attached figures, each core 2 is schematically represented and comprises one transmissive element 3 and an outer insulating layer 4. In particular, the embodiments of FIGS. 1, 1a and 2 present a single core 2, the embodiments of FIGS. 3, 3a and 4 present three cores 2 and the embodiment of FIG. 5 presents thirty cores 2.

The present invention deals with uni-polar or multi-polar heavy duty cables 1. With reference to the multi-polar cables, the cores 2 are preferably twisted one another to form a core cores 2, either in stranded configuration or not, can be wrapped by a tape, e.g. in paper or textile material (not shown).

The illustrated transmissive elements 3 are electrical conductors made of metal wires, for example copper, tinned copper or annealed tinned copper, stranded together according to conventional techniques or made of a single rigid conductor.

The cable according to the present invention can encompass diverse transmissive elements too, such as optical transmissive elements or combined electro-optical transmissive elements (not shown).

Independently of the kind and of the number of cores 2, the heavy duty cable 1 according to the invention comprises an outer sheath 5 disposed in radially external position with respect to said core 2.

Such outer sheath 5 advantageously comprises a reinforcing layer 6 comprising a fibril reinforced polymeric matrix.

In the present description and in the subsequent claims, the term “fibril” is used to indicate a small filament or threadlike element having typically the length of some tenth of millimetre. Said fibrils can have a diameter of from 0.1 μm to 1 μm.

In accordance with the embodiment of FIGS. 1 and 1a, the outer sheath 5 consists of said a reinforcing layer 6 comprising a fibril reinforced polymeric matrix.

The embodiments of FIGS. 3, 3a, 4 and 5 are multi-polar cables wherein the cores 2 form a strand.

As a result of its nature, the strand has a plurality of interstitial zones which are defined by the spaces comprised among the cores 2. In other words, the twisting of the cores 2 gives rise to a plurality of voids, i.e. the interstitial zones, which, in a transverse cross section along the longitudinal length of the strand, define an external perimetral profile of the latter of non-circular type.

Therefore, in order to allow the correct application of the successive layers in a position radially external to said stranding, a bedding 7, for example a polymeric material of the type as described hereinbelow, is applied by extrusion to fill said interstitial zones so as to confer to the stranding a substantially even transverse cross section, preferably of the circular type.

The cable of FIG. 4 is similar to the cable of FIG. 3 and further comprises a central messenger 8 around which the cores 2 are stranded.

The cable of FIG. 5 comprises a first strand of twelve cores 2 placed on a circumferential inner path and a second strand of eighteen cores 2 placed on a circumferential outer path, both paths being coaxial with respect to a central messenger 8.

In the embodiment of FIG. 4, the central messenger 8 is a polymeric fiber-based element, i.e. polymer fibers sunk into a polymeric matrix. In the embodiment of FIG. 5, the central messenger 8 is a composite structure comprising a polymeric fiber-based element with a polymeric coating 8a provided in a radially external position thereto.

Independently of the number of fibril reinforced layers 6, the outer sheath 5 is advantageously formed by extrudable materials only, so that it can be manufactured by one or more extrusion steps only.

Preferably, the reinforced layer 6 comprises a polymeric matrix, where the polymeric matrix is selected from the following materials: natural rubber, ethylene/vinyl acetate copolymer (EVA); chlorosulfonated polyethylene (e.g., marketed with the trademark Hypalon of DuPont); polychloroprene (PCP); chlorinated polyethylene (CPE); styrene-butadiene rubber (SBR); acrylonitrile-butadiene rubber (NBR).

The fibrils can be of inorganic or organic material, or both.

Examples or inorganic material for fibrils are glass material or metallic material (e.g. titanium, aluminium).

Examples of organic material for fibrils are polymeric material, carbon material, lignocellulosic material. For example, the polymeric material is selected from polyamide and polypropylene.

More preferably, the polyamide is aromatic polyamide (aramide).

In a preferred embodiment, the aromatic polyamide is poly-para-phenylene terephthalamide, marketed with the commercial names of Kevlar® and Twaron®. The fibrils of Kevlar® are known as Kevlar® pulp.

For example, the polymeric fibrils present an average length of from 0.1 mm to 2 mm.

The amount of fibrils in the fibril reinforced matrix layer of the invention can vary between wide limits. Nevertheless, the fibril reinforced matrix layer advantageously comprises from 1 to 30 phr of fibrils, preferably from 2 to 15 phr of fibrils.

The bedding 7 and the coating 8a can be made of polymeric material selected from natural rubber, ethylene/vinyl acetate copolymer (EVA); chlorosulfonated polyethylene; polychloroprene (PCP); chlorinated polyethylene (CPE); styrene-butadiene rubber (SBR); acrylonitrile-butadiene rubber (NBR).

Such bedding 7 and/or coating 8a are optionally provided with fibrils reinforcements.

In order to manufacture a cable of the invention, according to a first step of the method of the invention, the core 2 is prepared or the stranding of cores 2 are provided according to a pre-selected configuration, per se commonly known.

Subsequently, a material made of a first compound of fibrils and matrix, as above specified, is placed around the core 2, in order to form the reinforcing layer 6 comprising fibril reinforced polymeric matrix, said layer 6 being disposed in radially external position with respect to the cited core 2.

Preferably, the compound is extruded around the core 2 by means of an extrusion apparatus 10, known per se and therefore only partially and schematically shown in FIG. 6 during the manufacturing of the cable 1 illustrated in FIG. 2.

If the cable 1 presents, one or more beddings 7 in addition to the reinforcing layer 6 comprising a fibril reinforced polymeric matrix, such additional bedding 7 are extruded directly on the core 2 or stranding of cores 2, for example, by preparing a second compound and providing it around the core 2.

Preferably, the extrusion of the reinforcing layer 6 and the extrusion of the above cited beddings 7 and/or coatings 8a are performed in a single step by means of a co-extrusion process.

Alternatively, the extrusion of the above cited beddings 7 and/or coatings 8a and of the reinforcing layer 6 are performed in a plurality of steps.

With reference to FIG. 6, the extrusion apparatus 10 comprises an extrusion head 11 with a male die 12, an intermediate die 13 and a female die 14. The male die 12 is mounted within the intermediate die 13 and the intermediate die 13 is mounted within the female die 14. All the three dies 12, 13, 14 are coaxial with respect to a longitudinal axis “X” parallel to a conveying direction “A” of the core 2.

The head 11 is provided with a plurality of feeding channels 15 for the first compound of the layer 6 and with feeding channels 16 for the second compound of the outer sheath 5. Each of the feeding channels 15 flows into a passageway 17 shaped as truncated cone and opens as an inner annular aperture 18 around a central passage 19 for the core 2. Each of the feeding channels 16 flows into a passageway 20 shaped as truncated cone and opens as an outer annular aperture 21 placed around the inner annular aperture 18.

The first and second compounds to be extruded are made to flow within the respective passageway 17, 20, while the core 2 is fed along the conveying direction “A”, so as to distribute the materials in a substantially uniform manner onto the core 2, in order to manufacture the cable 1 of FIG. 2.

According to the illustrated embodiment, the reinforcing layer 6 of fibril reinforced polymeric matrix is arranged at a radially outer position with respect of and in reciprocal contact with the bedding 7.

The extrusion apparatus 10 shown in FIG. 6 is only by way of illustration. Indeed, the structure of the head 11 can be properly designed according to the kind of cable 1 to be manufactured.

### Example 1

Fibril reinforced matrix compounds were prepared according to the following Table 1, wherein the amount of components are provided in phr. The resulting samples were tested and provided the results set forth in the following Table 2. Sample 1 is provided as comparative example.

TABLE 1

| Sample | 1 | 2 | 3 | 4 | 5 |
|---|---|---|---|---|---|
| Neoprene ® | 100 | 96.3 | 92.5 | 85.0 | 70.0 |
| Rhenogran ® | — | 6.2 (2.5) | 12.5 (5) | 25.0 (10) | 50.0 (20) |
| P91-40/CR | | | | | |
| Perkasil ® | 37.7 | 37.7 | 37.7 | 37.7 | 37.7 |
| KS 300 | | | | | |
| Mistron ® | 27.1 | 27.1 | 27.1 | 27.1 | 27.1 |
| Vapor R | | | | | |
| Si 69 ® | 0.8 | 0.8 | 0.8 | 0.8 | 0.8 |

Neoprene ® = polycloroprene rubber marketed by DuPont
Rhenogran ® P91-40/CR = polychloroprene rubber containing 40% wt of para-phenylene terephthalamide fibrils (product marketed by Rhein Chemie); in parenthesis are provided the amount of fibrils provided in each mixture
Perkasil ® KS 300 = precipitated silica with a medium surface area and a fine particle size marketed by Akzo Nobel Chemicals Inc.
Mistron ® Vapor R = talc marketed by Luzenac America
Si 69 ® = silane coupling agent marketed by Degussa

TABLE 2

| Sample | 1 | 2 | 3 | 4 | 5 |
|---|---|---|---|---|---|
| Modulus at 10% (Mpa) | 1.1 | 2.9 | 6.6 | 11.1 | 16.0 |
| Viscosity (ml) | 29.4 | 28.4 | 27.6 | 27.3 | 28.9 |
| Scorch time (121°) t18 | 11:46 | 13:22 | 14:16 | 16:58 | 21:22 |

Modulus at 10% (Mpa) was determined according to CEI EN 60811-1-1 by stretching the sample longitudinally with respewt to the calendaring direction;
Viscosity ML and Scorch time (121°) t18 were determined according to ASTM D 1646-92.

The data above reported showed that the reinforced samples 2 to 5 according to the invention provided an improved workability to the material with respect to a not reinforced compound employed as a coating in the cables of the prior art.

According to the Applicant's observation, during the working process, the fibrils act as sliding planes, lowering the internal friction stresses. Such a behaviour was found to improve the scorch strength (higher scorch time) of the cable 1. The viscosity was substantially not affected.

Furthermore, the reinforced compounds 2 to 5 show an improved modulus of elasticity with respect to a not reinforced compound employed as a coating in the cables of the prior art.

### Example 2

The first example refers to the embodiment of FIG. 4 showing a strand of three cores 2, each having a rigid conductor 3 of tinned copper.

Each core 2 was provided with an insulating layer 4 of ethylene-propylene rubber (EPR).

The three cores 2 were surrounded by a bedding 7 filling the gaps between the cores 2 and made of synthetic rubber compound.

The outer sheath 5 consisted of a layer 6 of fibril reinforced matrix of a polychloroprene rubber containing 10 phr of para-phenylene terephthalamide fibrils

### Example 3

The second example refers to the embodiment of FIG. 5 showing a cable with eighteen plus twelve cores 2 provided around a central messenger 8 in para-phenylene terephthalamide fiber into the polichloroprene rubber.

Each core 2 had a conductor 3 of annealed tinned copper.

Each core 2 was provided with an insulating layer 4 of ethylene-propylene rubber.

The cores 2 were surrounded into a bedding 7 filling the gaps between the cores 2 and made of synthetic rubber compound.

The sheath 5 consisted of a layer 6 of fibril reinforced matrix of a polychloroprene rubber containing 10 phr of para-phenylene terephthalamide fibrils

### Example 4

The comparison between a heavy duty prior art cable provided with a composite outer sheath and the heavy duty cables of Example 1 and 2 (see data of following Table 2) shows that the cables according to the invention are endowed with the same mechanical properties of the prior art cable while having reduced weight and dimensions.

TABLE 3

| | Reference cable | |
|---|---|---|
| | (Control Cable) | EXAMPLE 3 |
| Outer sheath | Composite sheath | single |
| | (inner PCP layer + | layer of PCP |
| | Rayon fibers + | with Kevlar ® pulp |
| | external PCP layer | |
| Overall diameter (mm) | 40.0 | 35.0 |
| Net weight (Kg/m) | 2.31 | 1.90 |

TABLE 4

| | Reference cable | |
|---|---|---|
| | (Energy cable) | EXAMPLE 2 |
| Outer sheath | Composite sheath | Single PCP |
| | (inner PCP layer + | layer with |
| | metal layer + | Kevlar ® pulp |
| | external PCP layer) | |
| Overall diameter (mm) | 40.0 | 36.0 |
| Net weight (Kg/m) | 3.45 | 3.10 |

The use of the fibril reinforced polymeric matrix allows to avoid the use of a discontinuous layer made in form of braid or tape or filament and also of other extruded layers typically present in a reinforcing layer.

1-24. (canceled)

25. A cable comprising:
at least one core having at least one transmissive element; and
an outer sheath disposed in radially external position with respect to said core, wherein said sheath comprises at least one reinforcing layer comprising a fibril reinforced polymeric matrix.

26. The cable according to claim 25, comprising a heavy-cable.

27. The cable according to claim 25, wherein said outer sheath comprises at least one reinforcing layer consisting of a fibril reinforced polymeric matrix.

28. The cable according to claim 27, wherein said outer sheath consists of one reinforcing layer consisting of a fibril reinforced polymeric matrix.

29. The cable according to claim 25, wherein the fibril reinforced polymeric matrix comprises 1 to 30 phr of fibrils.

30. The cable according to claim 29, wherein the fibril reinforced polymeric matrix comprises 2 to 15 phr of fibrils.

31. The cable according to claim 25, wherein fibrils comprise a material selected from polymeric material, carbon material, lignocellulosic material, glass material and metallic material.

32. The cable according to claim 31, wherein the fibril material is a polymeric material.

33. The cable according to claim 32, wherein the polymeric material is selected from polyamide and polypropylene.

34. The cable according to claim 33, wherein the polyamide is an aromatic polyamide.

35. The cable according to claim 34, wherein the aromatic polyamide is poly-para-phenylene terephthalamide.

36. The cable according to claim 25, wherein the fibrils have an average length of 0.1 to 2 mm.

37. The cable according to claim 25, wherein the polymeric matrix comprises an elastomeric material.

38. The cable according to claim 25, wherein the matrix comprises a material selected from: natural rubber, ethylene/vinyl acetate copolymer, chlorosulfonated polyethylene, polychloroprene, chlorinated polyethylene, styrene-butadiene rubber and acrylonitrile-butadiene rubber.

39. The cable according to claim 25, wherein the outer sheath comprises at least one layer of non-fibril-reinforced polymeric material.

40. The cable according to claim 25, comprising a plurality of cores and a bedding.

41. The cable according to claim 40, wherein the bedding comprises a polymeric material selected from natural rubber, ethylene/vinyl acetate copolymer, chlorosulfonated polyethylene, polychloroprene, chlorinated polyethylene, styrene-butadiene rubber and acrylonitrile-butadiene rubber.

42. A process for manufacturing a cable, comprising the steps of:
providing a core having at least a transmissive element; and
applying a first compound of fibrils and a matrix around the core to form a reinforcing layer comprising a fibril reinforced polymeric matrix, said reinforcing layer being disposed in radially external position with respect to said core.

43. The process according to claim 42, further comprising the step of providing at least one bedding between the core and the reinforcing layer.

44. The process according to claim 43, wherein the bedding is provided by extruding a second compound on the core.

45. The process according to claim 44, wherein the second compound is a polymeric material.

46. The process according to claim 44, wherein the first compound and the second compound are co-extruded on the core.

47. A method for manufacturing a cable comprising providing fibrils as a coating layer for the cable.

48. The method according to claim 47, wherein the layer is a reinforcing coating layer.
